(19) United States
(12) Patent Application Publication
(10) Pub. No.: US 2005/0234852 A1
(43) Pub. Date: Oct. 20, 2005

(54) Apparatus and method for saving a file over a computer network

(76) Inventor: Sivakumar Coramutla, North Brunswick, NJ (US)

Correspondence Address: CAHN & SAMUELS LLP, 2000 P STREET NW, SUITE 200, WASHINGTON, DC, 20036, US

(21) Appl. No.: 11/024,037

(22) Filed: Dec. 29, 2004

Related U.S. Application Data
(60) Provisional application No. 60/532,637, filed on Dec. 29, 2003.

(51) Int. Cl. G06F 7/00

(52) U.S. Cl. 707/1

(57) ABSTRACT

The present invention relates to an apparatus and method for processing a file over a computer network. In at least one embodiment, the apparatus of the invention includes a computer server adapted for communication with a server database including at least one file accessible from a client computer. The apparatus further includes a document processing module including computer readable instructions for receiving a file identifier of the file from the client computer. A copy of the file identified by the file identifier is saved to the database upon receiving an instruction to save the copy and is prevented from being saved to any other location.

This application claims the benefit of U.S. provisional application Ser. No. 60/532,637, filed Dec. 29, 2003, which is herein incorporated by reference in its entirety.

### I. FIELD OF THE INVENTION

The invention relates to centralized document processing and, more particularly to apparatus and methods for remotely processing documents and saving the documents to a central location.

### II. BACKGROUND OF THE INVENTION

Computer users often access electronic documents remotely over a network such as the Internet. For example, a computer user using a client computer may access a document located remotely on a server computer by opening the document in a word processing program on the client computer. Access to the document is often shared amongst several users. Although several users may have a need to use the document, it is sometimes desirable to have one centrally located document on the server computer as opposed to having multiple versions of the same document on multiple client computers. Having a centrally located document often results in many advantages.

For instance, having a centrally located document may better enable a network administrator, for example, to track changes and access privileges to the document. Minimizing the effects of mishaps such as disk crashes, etc. by performing routine backups, for example, is also often easier if the document is centrally located, as the network administrator need only be concerned with performing file backup in one location. In addition to the above advantages, having a centrally located document also provides for one version of the document. As there is only one version of the document, users need not be concerned with whether the document they access is the most up-to-date version.

Although having an environment in which the document is centrally located has a variety of advantages, such an environment is often difficult to maintain. One of the reasons why such an environment is often difficult to maintain is due to the various users being able to create their own personal copies of the centrally located document. For instance, although a document may be located on the server computer, a user may access the document from his or her client computer and save the document to his local hard drive, for example, on his or her client computer. This often aids in minimizing or eliminating some or all of the advantages of a centrally located document environment. If several client computer users, for example, are allowed to locally save the file, tracking of the file may become more difficult.

In view of the foregoing, what is needed is a method and apparatus for processing a file over a network to maintain a centrally located document on a computer server.

### III. SUMMARY OF THE INVENTION

The present invention relates to an apparatus and method for processing a file over a computer network. In at least one embodiment, the apparatus of the invention includes a computer server adapted for communication with a server database including at least one file accessible from a client computer. The apparatus further includes a document processing module including computer readable instructions for receiving a file identifier of the file from the client computer. A copy of the file identified by the file identifier is saved to the database upon receiving an instruction to save the copy and to prevent the copy from being saved to another location.

### IV. BRIEF DESCRIPTION OF THE DRAWINGS

Like reference numerals in the figures represent and refer to the same element or function throughout.

FIG. 1 illustrates an exemplary client-server computing environment 100 in which the present invention may be employed including a server computing site and a client computing site according to at least one embodiment of the invention.

FIG. 2A is an exemplary block diagram illustrating various exemplary functional processes that are executed on a client computer according to at least one embodiment of the present invention.

FIG. 2B is an exemplary block diagram illustrating various exemplary functional processes that are executed on a server computer according to at least one embodiment of the present invention.

FIG. 3 is a general flow diagram of the present invention.

FIG. 4 is a flow diagram for performing the method of FIG. 3 according to at least one embodiment of the present invention.

FIG. 5A is an exemplary flow diagram of the process of step 405 of FIG. 4.

FIG. 5B shows a query building user interface.

FIG. 5C illustrates a search result list GUI.

FIG. 6 is an exemplary flow diagram of the process of step 410 of FIG. 4.

FIG. 7 is an exemplary flow diagram of the process of step 415 of FIG. 4.

FIG. 8 is an exemplary flow diagram of the process of step 420 of FIG. 4.

FIG. 9 is an exemplary flow diagram of the process of step 425 of FIG. 4.

FIG. 10 is an exemplary pictorial diagram illustrating operation of the system and method according to at least one embodiment of the invention.

FIG. 11 shows a modified browser window in accordance with the invention.

### V. DETAILED DESCRIPTION OF THE DRAWINGS

The present invention relates to an apparatus and method for saving a document, that is, an electronic file, accessed via a client computer to a server database over a computer network, e.g., the Internet, and preventing the document from being saved to another location such as the client computer. Although an Internet transfer protocol such as TCP/IP may be used to transmit the document over the Internet as a string, the document is preferably saved in its original format, for example, Microsoft Word.® Saving the document to the server database provides access to a centrally located document and may enable better management and tracking of the document, for example, better document access (e.g., read/write), and version control. In addition, a more reliable system may be created, as processes to backup the document may be easier to perform due to the central location of the file.

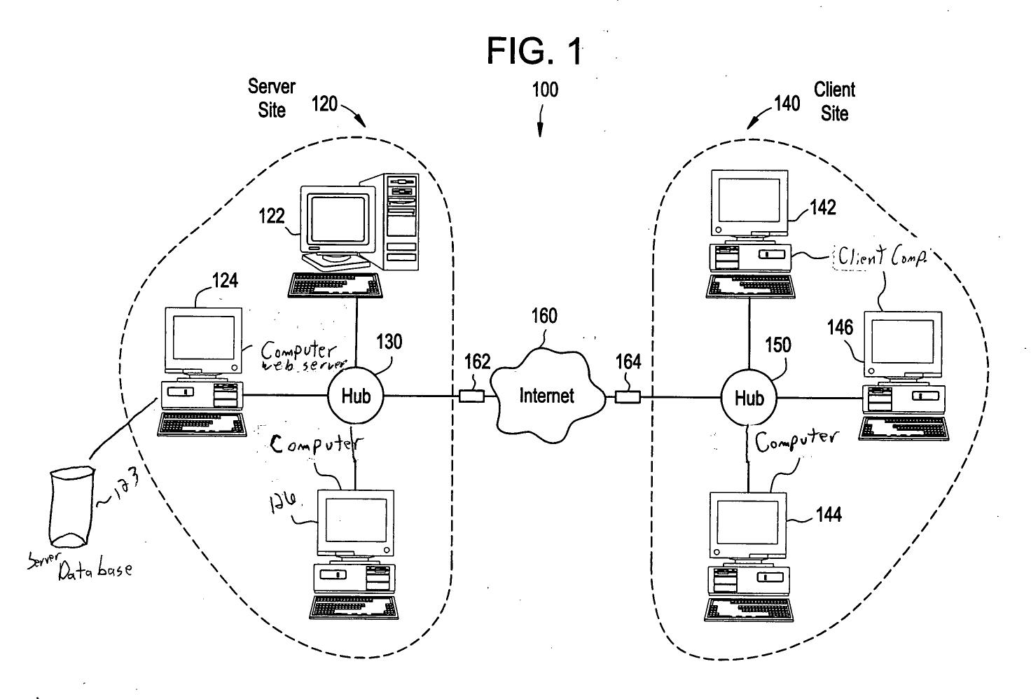

FIG. 1 illustrates an exemplary client-server computing environment 100 in which the present invention is preferably utilized. Although FIG. 1 illustrates a client-server computing environment, it should be noted that the illustration is presented for exemplary purposes. After being presented with the disclosure herein, those of ordinary skill in the relevant art will realize that other computing environments may be utilized in conjunction with the invention.

The computing environment 100 preferably includes a server computing site 120, for example, a server computing network, and a client computing site 140, for example, a client computing network.

The client computing site 140 is preferably electronically coupled to the server computing site 120 through the Internet 160 via the bridges or routers 162 and 164. In at least one embodiment of the invention, however, the bridges or routers 162 and 164 are not present. In such an embodiment, hubs 130 and 150 are preferably directly electronically coupled to the Internet. In such a situation, the hubs 130 and 150 are preferably replaced by bridges or any other routing mechanism, as would be known to one skilled in the relevant art(s). Further, it should be noted, however, that in some embodiments of the present invention, the server computing site 120 is preferably electronically coupled to the client computing site 140 directly via a main bridge (not shown). In such a configuration, the Internet 160 is replaced by the main bridge, and the system preferably operates on a private network, for example, an intranet, as opposed to the Internet. Regardless of the communication configuration, however, a user at the client computer site 140 preferably accesses a document stored on a server database 123 at the server site 120. It should be noted that the database may be located on a separate storage location but electronically coupled to the computer web server 124. In at least one embodiment, the database resides on the computer web server 124, as would be known to those of ordinary skill in the art after being provided with the disclosure herein.

As depicted in FIG. 1, the server computing site 120 preferably includes computer web server 124 and computers 122 and 126, for example. At least one individual such as a system or network administrator is preferably a user of one of the workstations 122 and 126. The workstations 122 and 126 preferably communicate through the hub 130 according to a communications method well known to those of ordinary skill in the relevant art.

In at least one embodiment, the computer web server 124 includes a plurality of modules such as computer program modules for program execution. Execution of the program modules allows a user at one of the client computers, computer 144, for example, at the client computing site 140 to access the system of the present invention, as will be described further herein below.

The client computing site 140 preferably includes computers 142, 144, and 146. At least one individual such as a medical professional is preferably a user of one of the workstations 142, 144, and 146. The workstations 142, 144, and 146 preferably communicate electronically with each other through the hub 150 according to a telecommunications method well known to those of ordinary skill in the art.

In addition to communication between users at each site, a user at the client site 140 preferably accesses information stored at the server site 120. For example, an individual using client computer 144 at the client site 140 may activate a web browser residing on the client computer 144 and access a word processing document with read/write privileges, for example, stored on the server database 123. After accessing and editing the stored document, the individual may instruct client computer 144 to save the document's changes. In at least one embodiment, the present invention preferably saves a copy of the document including the changes to the server database 123 and prevents the copy from being saved to another location such as the client computer 144 at the client site 140. By permitting the document to be saved in a single location only, the present invention creates a centrally located document library, which leads to reliable and easily managed version control.

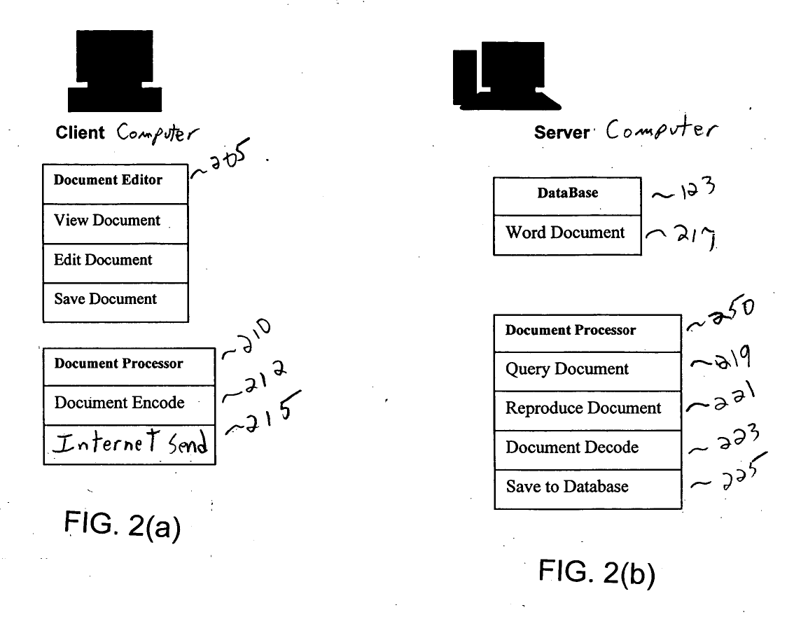

Referring now to FIG. 2A, in accordance with an embodiment of the invention, each client computer, for example, client computer 142, preferably includes a plurality of computer processes or routines emobodied in modules or submodules. For example, in at least one embodiment, each process is a computer program module residing on the client computer 142, for example, including computer readable instructions for performing a task.

In at least one embodiment, the client computer 142 includes a document editor routine 205 and a document processor routine 210. After viewing or editing the document using document editor routine 205, the document is preferably processed, for example, encoded, and transmitted across the network by document processor routine 210.

As described in the text accompanying FIG. 1, the computer web server 124 is preferably in communication with a database such as server database 123, for example. The database preferably stores at least one application file 217, for example, a word processor application file such as a Microsoft Word® document file in bit file format.

As shown in FIG. 2B, the document processor routine 250 of the computer web server 124 preferably includes a query document routine 219, a reproduce document routine 221, a document decode routine 223, and a save to database routine 225.

In at least one embodiment, the document processor routine 250 performs a first set of tasks and a second set of tasks. The first set of tasks includes querying a document via, for example, query document routine 219, requesting a document, retrieving the requested document from the server database, and allowing a user to access the document from a client computer.

The second set of tasks includes receiving an edited file, for example, from a client computer, converting the file to user viewable format, and storing the file to the server database, as will be described in more detail herein below. In at least one embodiment, these tasks are performed via query document routine 219, reproduce document routine 221, document decode routine 223, and save to database routine 225.

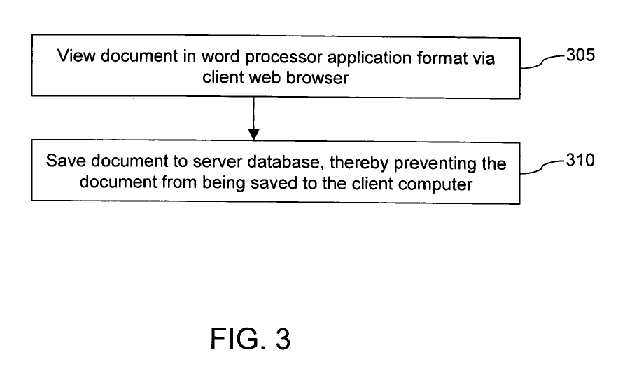

Referring to FIG. 3, a high-level overview of a process according to the present invention is illustrated. In step 305, a document is retrieved for viewing in application program format, word processor application format for example, via a web browser on a client computer 142. In keeping with the invention, the user need not open the application program to view the document. For instance, in at least one embodiment, a user residing at the client computer 142 preferably opens a computer browser such as Microsoft Internet Explorer® or Netscape Navigator® and types in a URL or web address. After preferably logging into the website and initiating a query of the server database 123 in FIG. 1, the user selects a desired document, for example, a Microsoft Word® document, from a query results list. After the user selects the document to view in the computer web browser, the user may edit the document, delete, add, or modify portions of the document.

In step 310, the user of the client computer preferably directs the client computer to save the document by e.g., selecting an electronic “save file” button, on a graphical user interface (GUI) using an input device such as a computer mouse. Responsive to that direction, the client computer transmits a save instruction to the server computer. A copy of the document is then saved to the server database while maintaining the document's original file format of Microsoft Word®. In accordance with the invention, the document is prevented or blocked from being saved to any other location such as a client computer

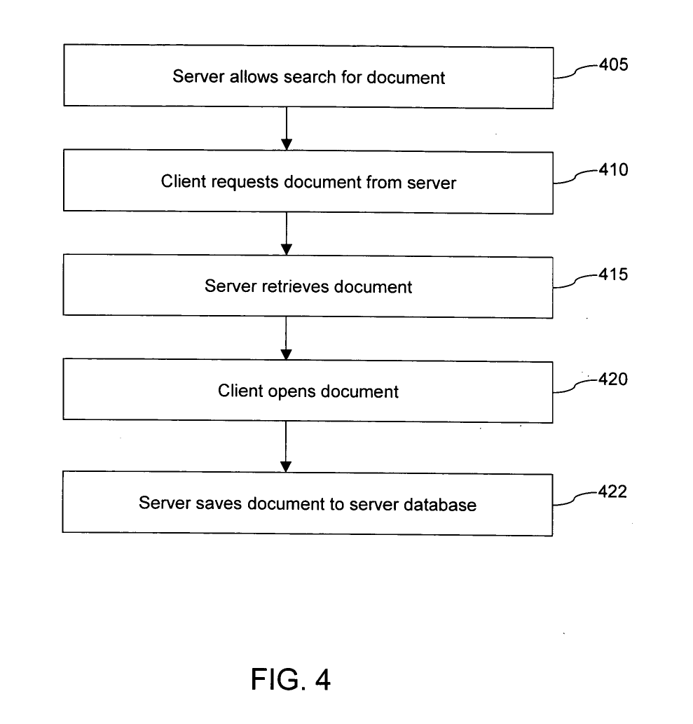

FIG. 4 provides a more detailed flow diagram of an exemplary process of the present invention. In step 405, the server computer conducts a search for the document responsive to a document query from the user, for example.

In step 410, the client computer requests the document from the server computer. For example, in at least one embodiment, the client computer 142 transmits a document request instruction via the Internet to the computer web server 124 responsive to user request.

In step 415, the computer web server retrieves the document from the server database 123 and allows the client computer 142 to access the document.

In step 420, the client computer 142 opens the document to allow a user of the client computer 142 to view and or edit the document, for example.

In step 422, the server saves a copy of the document to a server database and prevents the document from being saved to another location. The document's Microsoft Word® format, for example, a bit file encoded with Micrsoft Word® codes is preferably maintained.

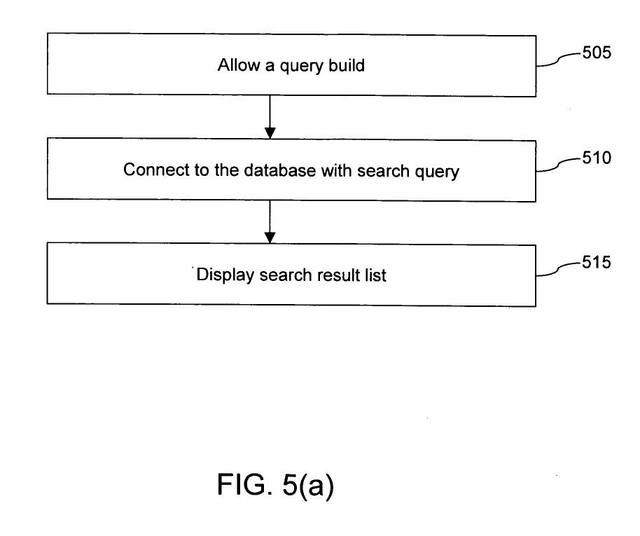

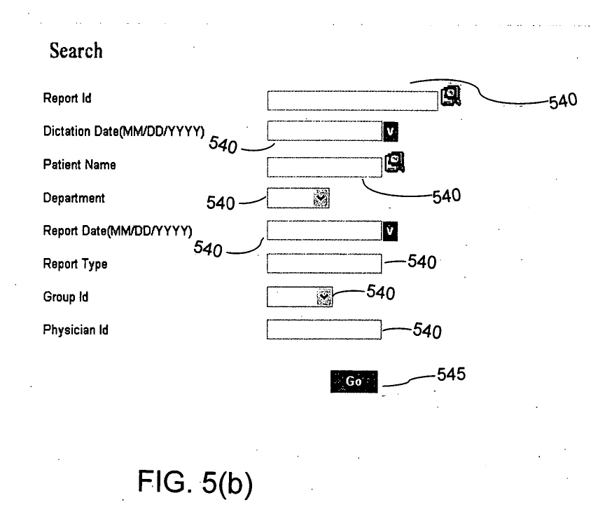

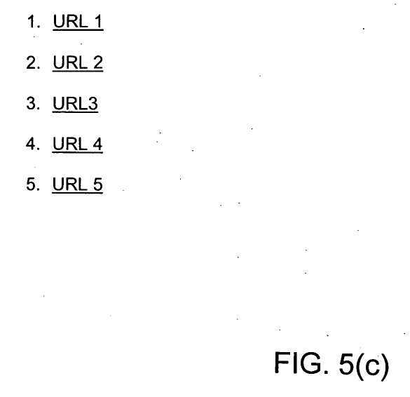

FIG. 5A illustrates a flow diagram of the process of step 405. In step 505, the server computer preferably performs a query build. In at least one embodiment, in order to assist a user in initiating a query, computer web server 124 provides a query building user interface or GUI to be accessed by the user via the client computer. The GUI preferably includes a plurality of data inputs, e.g. dialog boxes, radio buttons and the like, where each data input corresponds to an associated data field of server database 123. An exemplary user interface is illustrated in FIG. 5B. The exemplary user interface includes data inputs 540 in the form of dialog boxes.

In step 510, after the query has been built, the computer web server 124 preferably connects to the server database 123, for example. In at least one embodiment, when a user clicks on a “search” button, the search query built in step 505 is transmitted to the server database 123 and a search result set is produced and displayed on a monitor attached to the client computer 142.

In step 515, a list of search results from the query is displayed on the monitor of client computer 142. In at least one embodiment, the search results list is a user interface used to display search result links. An exemplary GUI of the search result list is illustrated in FIG. 5C including search result list 560 comprising one or more file links 565.

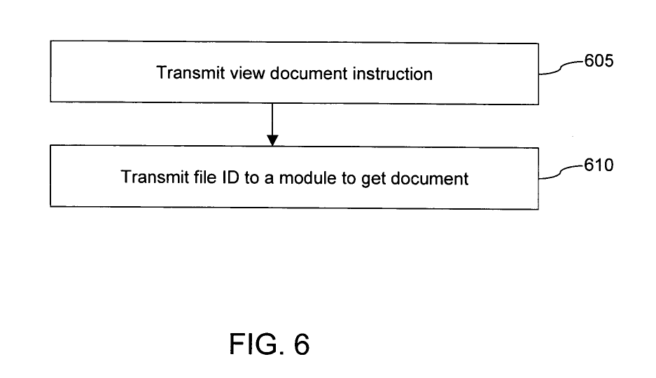

FIG. 6 illustrates a more detailed flow diagram of the process of step 410. In step 605, in at least one embodiment, the client computer 142 transmits an instruction to the computer web server 124 to view the document. In at least one embodiment, transmission of the instruction is accomplished in step 605 of FIG. 6 by allowing a user to select a file link 565 in the search results list and clicking a “view document” button (not shown) to cause the client computer 142 to transmit the instruction to the computer web server 124.

In step 610, the client computer 142 preferably transmits a file identifier to a module or process on the computer web sever 142 to allow the computer web server 124 to identify the desired document to be viewed.

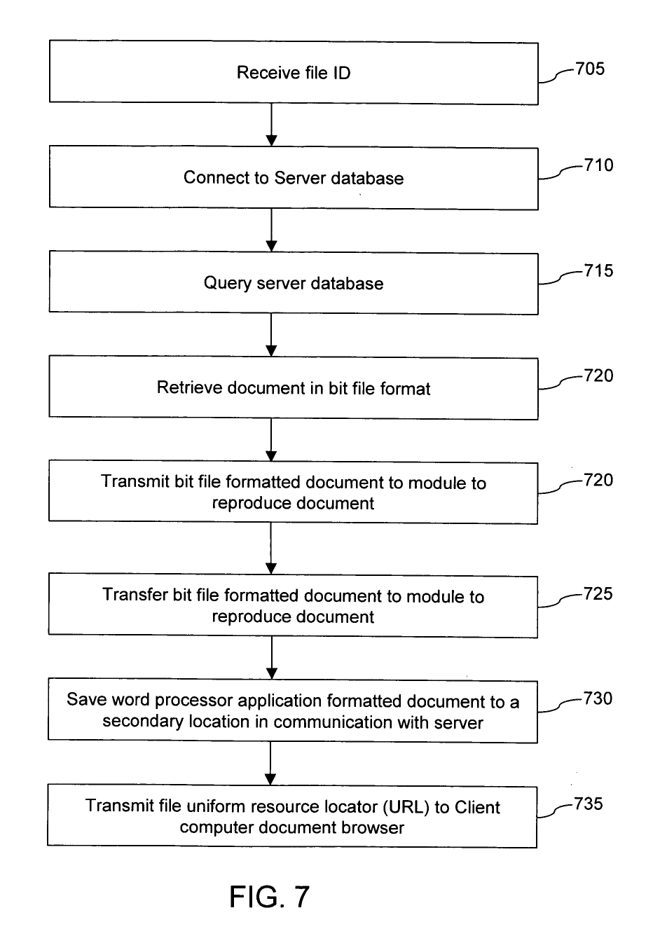

FIG. 7 depicts a more detailed flow diagram of the process of step 415. In step 705, the computer web server 124 receives the file identifier of the document to be retrieved. In at least one embodiment, a “get document” routine executed on the computer web server 124 may receive the file identifier via the Internet, for example, when the file identifier is transmitted from the client computer 142.

In step 710, the computer web server 124 connects to the server database 123 in preparation for document query.

In step 715, the server database 123 is queried. In at least one embodiment, the query document routine 219 shown in FIG. 2B queries the database 123 to retrieve a bit file, in step 720.

As the document stored in the database is a bit file and not viewable by a user, it should be converted to user-viewable format. In at least one embodiment, in step 725, the query document routine 219 shown in FIG. 2B transmits the file to another routine to convert the file.

In step 730, in at least one embodiment, the reproduce document routine 221 residing on the computer web server 124 receives the bit file and transfers or converts the bit file to a user viewable file format. The user viewable file format may be any desired application file format such as a word processing file format, a spread sheet file format, a database file format, etc. In an exemplary embodiment, a copy of the file is encoded with Microsoft Word® formatting codes.

In step 735, the reproduce document routine 221 of FIG. 2B saves the copy, that is, the Microsoft Word® encoded file, in a secondary location such as temporary storage. It should be noted that in at least one embodiment of the invention, step 735 need not be performed. In such an embodiment, the document itself is stored in a user-viewable application file format and a copy of the document in a user-viewable format does not need to be stored.

Finally, step 740 describes the operation of a uniform resource locator (URL) transmission document submodule. In step 740, the URL of the user-viewable copy of the document residing in the secondary location is transmitted from the computer web server 124 to the client computer 142. For example, in at least one embodiment, the web browser software executed on the client computer 142 receives the URL of the copy stored in the secondary location.

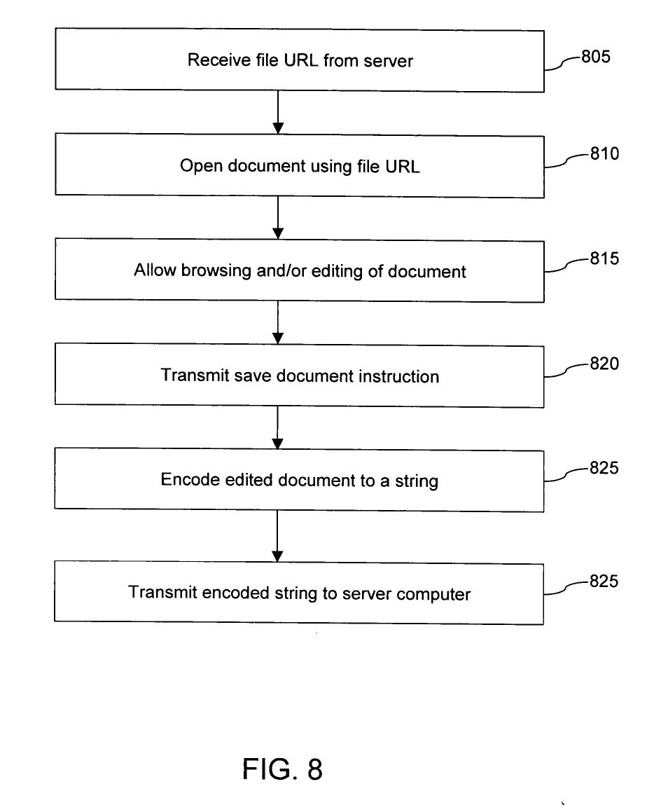

Referring now to FIG. 8, it shows a more detailed flow diagram of the process performed by step 420. In step 805, the URL of the document copy is received by the client computer 142, for example.

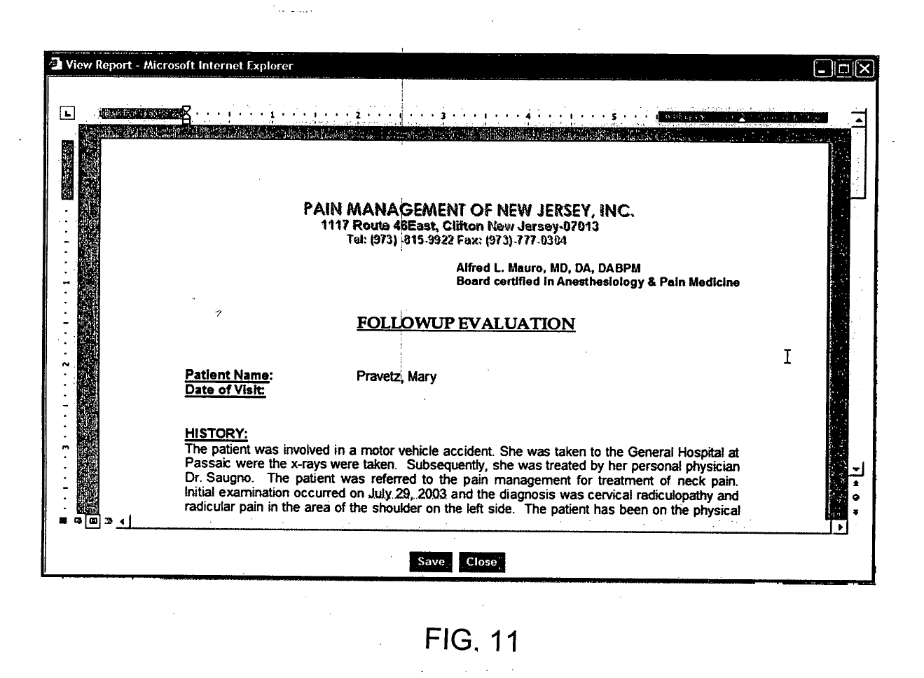

In step 810, using the URL of the document copy, the client computer 142 opens the document in a modified browser window. The modified browser window permits the user to edit the document, save the document to a remote storage location, e.g., the server database, or close the document. FIG. 11 depicts an exemplary modified browser window including a document 1105, a save button 1110, and a close button 1115. In at least one embodiment, a Microsoft Word® document copy is opened via a web browser on the client computer 142, such as Internet Explorer or Netscape Navigator. In step 815, the copy of the document is browsed or edited.

In step 820, a save document instruction is transmitted from the client computer 142 to the computer web server 124. For example, the save document instruction may be transmitted from the client computer 142 after the user clicks on a “save document” electronic button 1110 of FIG. 11.

In step 825, the document encode routine 212 shown in FIG. 2A, for example, encodes the edited document copy from its native application file format, e.g., Microsoft Word® format, to a file format suitable for transmission over the Internet, such as a string file format.

In step 830, in at least one embodiment, the Internet send routine 215 shown in FIG. 2A transmits the string encoded document copy including the new changes to the computer web server 124.

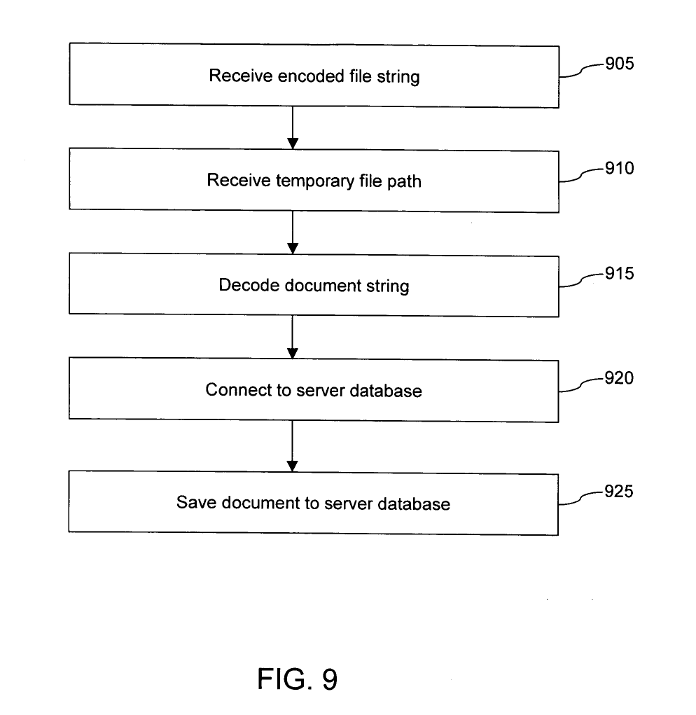

FIG. 9 illustrates a more detailed flow diagram of the process of step 422. In step 905, the computer web server 124 receives the string file encoded Microsoft Word® document copy from the client computer 142.

In step 910, a temporary file path is received. For example, in at least one embodiment, the temporary file path is used to store a backup copy of the document. In step 915, the document decode routine 223 on the computer web server 124 preferably decodes the string file encoded Microsoft Word® document copy. In step 920, the computer web server 124 preferably connects to the server database. Finally, in step 925, the document copy is saved to the server database in bit file format. In at least one embodiment, the previous bit file representation of the document copy, that is, the bit file format of the document copy before the user made changes, is overwritten with the new bit file created in step 915. The document has now been saved to the server database and has been prevented from being saved to another location such as the client computer 142, thereby resulting in a centrally stored file which can aid in easier file management and tracking, for example, identification of users who accessed and/or edited the file.

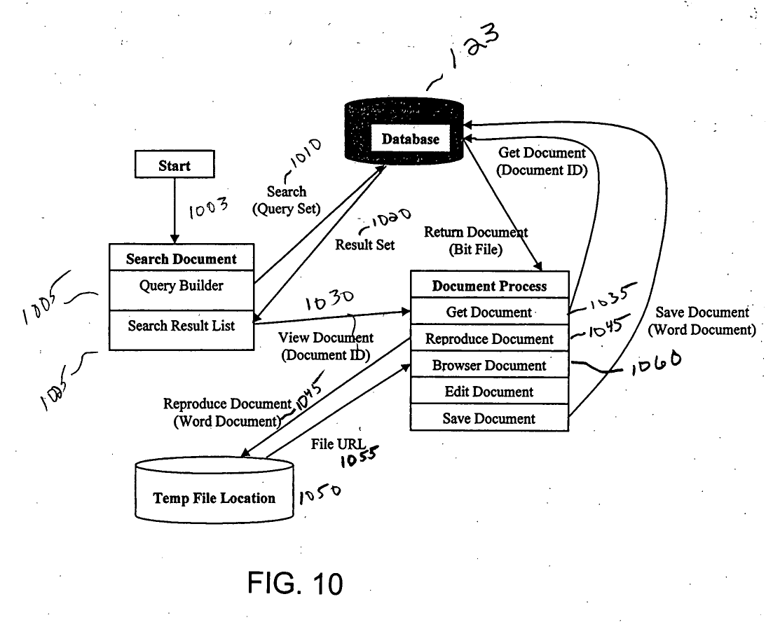

Referring now to FIG. 10, a pictorial diagram of the process illustrated by FIGS. 5-9 is presented. In at least one embodiment, after a user is allowed to login to the system, a query builder process or program module 1005 transmits a query set 1010 to the server database 123. The database then returns a search result set 1020 to the search result list routine 1025. After the user clicks on a document displayed by the search result list process 1025 with his or her mouse, for example, to view the document, the document identifier (ID) 1030 is transmitted to the get document process 1035. The get document process 1035 then retrieves the document from the server database 123 using the document identifier 1030. The reproduce document process 1045 then receives the document in bit file format, converts or transfers the document to a user viewable file format such as Microsoft Word® and stores this document, a copy of the bit file in user-viewable file format, to a temporary or secondary file location 1050. After the user viewable file formatted document copy is stored, the file URL 1055 of the document copy stored in the temporary or secondary file location 1050 is transmitted to the browser document process 1060 on the client computer. After the user browses or edits the document copy, the document copy is saved to the server database 123 and is blocked from being saved to another location such as a client computer.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings. Although Microsoft Word® documents were referred to herein, it should be noted that such references were used for explanatory purposes. Other types of documents can also be used, for example, Adobe Acrobat® documents, databse documents (e.g. Microsoft Access), spreadsheet documents, (e.g. Microsoft Excel), presentation software documents (e.g. Microsoft Powerpoint), etc.

The present invention is applicable to any document processing environment. For example, the invention is well suited to the field medical transcriptions as it allows healthcare providers to edit documents created by medical transcriptionists in a secure and trusted fashion. The invention may also be employed in document management software to allow organizations better control of the integrity of their documents.

Those skilled in the art will appreciate that various adaptations and modifications of the exemplary and alternative embodiments described above can be configured without departing from the scope and spirit of the invention. Therefore, it is to be understood that, within the scope of the appended claims, the invention may be practiced other than as specifically described herein.

1. An apparatus for saving document to a document storage location comprising:
a search module that searches a database for a document responsive to receipt of a query from a remote computer and retrieves the document in a first file format;
a transmission module that transmits a URL of the document to the remote computer to allow user modification of the document;
a reception module that receives the modified document in a second file format from the remote computer; and
a saving module that saves the modified document in the first file format to the document storage location and prevents the modified document from being saved on the client computer.

2. The apparatus of claim 1 further comprising a conversion module that converts the document from a first file format to a user viewable file format prior to URL transmission.

3. The apparatus of claim 2 wherein the first file format is a bit file format.

4. The apparatus of claim 2 further comprising a temporary saving module that saves the converted document in a temporary storage location.

5. The apparatus of claim 1 wherein the document storage location is the database.

6. The apparatus of claim 1 wherein the document storage location is the database.

7. The apparatus of claim 2 further comprising means for providing read/write access to the document to thereby permit modification of the document by a user.

8. The apparatus of claim 7 further comprising an encode module that encodes the modified document to a second file format for transmission over a network.

9. The apparatus of claim 8 wherein the reception module decodes the modified document into the first file format.

10. A method in a computer network for modifying a document comprising:
transmitting a document request to a remote computer;
receiving a URL of the requested document from the remote computer responsive to the request;
opening the document and providing read/write access to the document to allow a user to modify the document;
after modification of the document by the user, encoding the modified document to a file format suitable for transmission over a computer network; and
transmitting the encoded document to the remote computer.

11. A computer-readable medium having computer executable instructions for performing the method of claim 10.

12. The method of claim 10 wherein transmitting the document request includes transmitting a file identifier to the remote computer.

13. The method of claim 12 wherein encoding the modified document includes encoding the modified document to a string file format.

14. A computer-readable medium having computer executable instructions for performing the method of claim 13.

15. A data signal embodied in a transmission medium readable by a computing

16. An apparatus for processing a file over a computer network, comprising:
a computer server adapted for communication with a server database including at least one file in a first file format accessible from a client computer; and
a document processing module including computer readable instructions for receiving an identifier of said file from said client computer and saving a copy of said file to said database upon receiving an instruction to save said copy and to prevent said copy from being saved to another location.

17. The apparatus of claim 16, wherein said document processing module further includes:
a reproduce document submodule including computer readable instructions for receiving said file in said first file format before said save occurs, converting said file to a second file format, thereby producing said copy of said file in said second file format at a secondary location before said save occurs;
a URL transmission document submodule for transmitting a file URL of said copy to said client computer to allow said client computer to access said copy before said save occurs;
a document decode submodule including computer readable instructions for receiving said copy after said copy has been encoded to a third file format by said client computer and converting said copy from said third file format to said first file format, before said save occurs; and
a save file submodule including computer readable instructions for receiving said copy in said first file format and saving said copy to said server database in said first file format.

18. The apparatus of claim 17, wherein said document processing module further includes a query document submodule including computer readable instructions for allowing said server database to be queried to retrieve said file.

19. The apparatus of claim 18, wherein said query document submodule includes:
a query build submodule including computer readable instructions for allowing a user to build a search query;
a database connection submodule including computer readable instructions for connecting to said database; and
a query results submodule including computer readable instructions for displaying search result links from said search query.
